(19) United States
(12) Patent Application Publication
(10) Pub. No.: US 2011/0298378 A1
(43) Pub. Date: Dec. 8, 2011

(54) Light-emitting diode (LED) protection structure

(75) Inventors: Yi-Yu Tsai, San Chung City (TW); Yi-Hua Li, San Chung City (TW)

(73) Assignee: Unity Opto Technology Co., Ltd., San Chung City (TW)

(21) Appl. No.: 12/801,990

(22) Filed: Jul. 7, 2010

(30) Foreign Application Priority Data
Jun. 7, 2010 (TW) 099210784

(51) Int. Cl. H05B 41/00

(52) U.S. Cl. 315/127

(57) ABSTRACT

A light-emitting diode (LED) protection structure includes an LED portion and a protection portion. The protection portion includes a fuse and a Zener diode connected in series. The protection portion is electrically connected to the LED portion in parallel but opposite in direction. As such, the LED protection structure can effectively protect the LEDs and the Zener diode from being damaged to thereby reduce costs.

### FIELD OF THE INVENTION

The present invention relates to a light-emitting diode (LED) protection structure, and in particular to an LED protection structure comprising a fuse and a Zener diode.

### BACKGROUND OF THE INVENTION

After the invention of lighting bulb by Thomas Alva Edison, lighting becomes essential to human society. The subsequent development of fluorescent tubes further upgraded lighting technology. In 1960, a light-emitting diode (LED) made a new page of human lighting history and the LED brings new hope to the lighting industry with its characteristics of power saving, long lasting service life, and reduced heat generation. Due to technical constraints, it was only after 1993 that a blue LED was successfully developed to completely satisfy visual sense of human eyes for primary colors of red, green, and blue. This further advances the application of LED.

Being similar to general electronic devices, an LED is susceptible to damage caused by abnormal electric phenomenon, such as electrostatic discharge, surge, or inrush current, during the manufacturing process or the use thereof. This is an even severer problem for GaN series LED products, including products of blue light, green light, white light, and ultraviolet light, for the GaN material is weak in resisting static electricity and thus it is easily damaged by static electricity during the use thereof. Apparently, to protect an LED from damages caused by electrostatic discharge during the manufacturing and use thereof is an important issue for designing and using LEDs.

Manufacturers adopt a solution of adding a Zener diode in the design of LED-included circuits in such a way that the Zener diode and the LEDs are arranged in parallel but opposite in direction. Under a normal condition, when a forward working voltage is applied, the input voltage causes the conduction of current through only the LEDs to give off light, but not the Zener diode. However, when an abnormal electrical phenomenon, such as electrostatic discharge, surge, or inrush current, occurs, an excessively large voltage is caused and such a large voltage makes the Zener diode breaking down, conducting most of the current through the Zener diode rather than the LEDs.

However, the manufacturing of Zener diode is complicated, making it not easy to lower down the manufacturing cost thereof. Thus, it is desired to prevent both the LEDs and the Zener diode from being damaged in an abnormal electrical phenomenon in order to further reduce the manufacturing cost.

### SUMMARY OF THE INVENTION

An objective of the present invention is to provide a light-emitting diode (LED) protection structure, which comprises a fuse that is arranged in front of a Zener diode to protect the Zener diode that is of a high manufacturing cost, so as to provide an efficacy of lowering the cost of using LED circuits.

To realize the above objective, the present invention provides an LED protection structure, which comprises an LED portion and a protection portion. The protection portion comprises a fuse and a Zener diode connected in series. The protection portion is electrically connected to the LED portion in parallel but opposite in direction.

In a preferred embodiment according to the present invention, the LED portion comprises at least one serially-connected LED. It is also possible to use a number of LEDs that are put in parallel electrical connection. To accommodate diverse LED circuits, the LED portion may be composed of multiple serially-connected LED sets, wherein the multiple serially-connected LED sets are electrically connected in parallel to each other and each serially-connected LED set comprises at least one LED connected in series.

### BRIEF DESCRIPTION OF THE DRAWINGS

The present invention will be apparent to those skilled in the art by reading the following description of preferred embodiments thereof with reference to the drawings, in which:

FIG. 1 is a schematic circuit diagram showing a light-emitting diode (LED) protection structure according to a first embodiment of the present invention;

FIG. 2 is a schematic circuit diagram showing an LED protection structure according to a second embodiment of the present invention; and

FIG. 3 is a schematic circuit diagram showing an LED protection structure according to a third embodiment of the present invention.

### DETAILED DESCRIPTION OF THE PREFERRED EMBODIMENTS

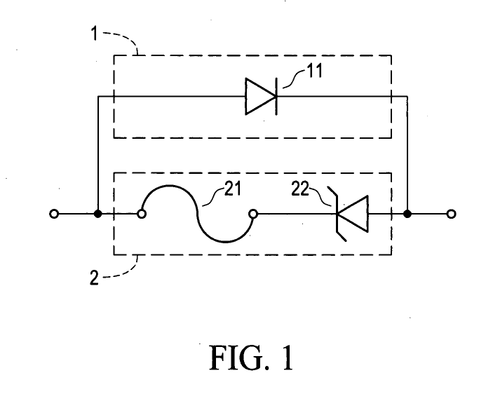

With reference to the drawings and in particular to FIG. 1, which shows a schematic circuit diagram of a light-emitting diode (LED) protection structure according to a first embodiment of the present invention, the LED protection structure according to the present invention comprises an LED portion 1 and a protection portion 2. In the embodiment illustrated, to simplify the description, only one LED 11 is shown for the LED portion 1. It is apparent that it can be made in such an arrangement that more than one LED 11 is electrically connected in series. The LED 11 can be a GaN series LED. The protection portion 2 comprises a fuse 21 and a Zener diode 22 that are electrically connected to each other in series. The protection portion 2 is electrically connected to the LED portion 1 in parallel but in opposite direction.

With such an arrangement, an input voltage causes a forward biasing between opposite ends of the LED portion 1 to conduct electrical current therethrough to make the LED 11 emitting light. However, such an input voltage induces a reversed biasing between opposite ends of the protection portion 2, so that the protection portion 2 is in an open-circuit condition. When an abnormal electrical phenomenon, such as electrostatic discharge, surge, or inrush current, an instantaneous excessively-large input voltage is caused, which might as large as 8-30 kV; this breaks down the Zener diode 22 so that most of the electrical current flows through the Zener diode 22 but not the LED 11, whereby the LED 11 is protected. However, once the instantaneous input voltage exceeds the breakdown voltage of the Zener diode 22, the Zener diode 22 may be damaged by such a voltage. Under such a condition, the fuse 21 that is connected in series to the Zener diode 22 will be melted down to provide further protection to the LED circuit.

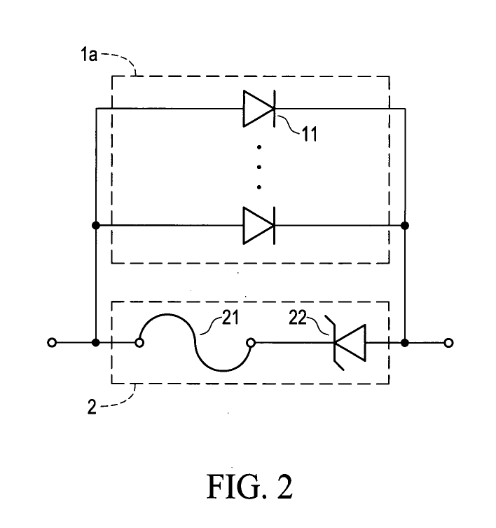

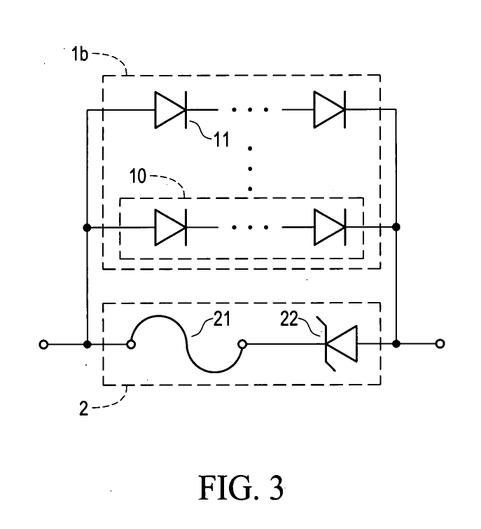

In the following descriptions of other embodiments of the present invention, since most of the components/parts are similar to the counterparts thereof adopted to the previously described embodiment, these components/parts that are identical or similar to each other will bear the same reference numerals with only a postfix character added for distinction. And, repeated description of the identical components/parts/portions will be omitted. Reference is now made to FIG. 2, which shows a schematic circuit diagram of an LED protection structure according to a second embodiment of the present invention. To accommodate different structures of LED circuit, the second embodiment of the present invention provides an LED protection structure that comprises an LED portion 1a that is composed of a plurality of LEDs 11 electrically connected to each other in parallel. Further referring to FIG. 3, which shows a schematic circuit diagram of an LED protection structure according to a third embodiment of the present invention, in which the LED protection structure according to the present invention comprises an LED portion 1 b is composed of multiple serially-connected LED sets 10, which are electrically connected to each other in parallel. Each of the serially-connected LED set 10 comprises at least one serially-connected LED 11.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light-emitting diode (LED) protection structure, comprising:
an LED portion; and
a protection portion, which comprises a fuse and a Zener diode electrically connected to each other in series, the protection portion being electrically connected to the LED portion in parallel but in opposite direction.

2. The LED protection structure as claimed in claim 1, wherein the LED portion comprises at least one LED connected in series.

3. The LED protection structure as claimed in claim 1, wherein the LED portion comprises a plurality of LEDs electrically connected to each other in parallel.

4. The LED protection structure as claimed in claim 1, wherein the LED portion comprises multiple LED sets, which are electrically connected to each other in parallel, each of the LED sets comprising at least one LED connected in series.
